(19) United States
(12) Patent Application Publication
(10) Pub. No.: US 2026/0225325 A1
(43) Pub. Date: Aug. 6, 2026

(54) METHOD AND PLANT FOR MANUFACTURING SLABS MADE OF STONE OR STONE-LIKE AGGLOMERATE MATERIAL AND HAVING VEINS AND SURFACE CHROMATIC EFFECTS AND SLAB SO OBTAINED

(71) Applicant: Luca Toncelli, Bassano del Grappa (VI) (IT)

(72) Inventor: Luca Toncelli, Bassano del Grappa (VI) (IT)

(21) Appl. No.: 19/143,314

(22) PCT Filed: Jan. 12, 2024
(86) PCT No.: PCT/IB2024/050325

§ 371 Date: Jun. 25, 2025

(30) Foreign Application Priority Data
Jan. 16, 2023 (IT) 102023000000510

(51) Int. Cl. B29C 67/24; B28B 1/00; B28B 13/02; B29C 67/00; B44C 5/04

(52) U.S. Cl. CPC B29C 67/243; B28B 1/005; B28B 13/0295; B29C 67/0007; B44C 5/04

(57) ABSTRACT

Manufacturing slabs made of stone or stone-like agglomerate material and having veins and surface chromatic effects, including steps of: distribution, of at least one layer of mix including a binding resin, formation of veins in the at least one layer of mix, compaction of the at least one layer of mix, catalysis of the binding resin of the mix, cooling of the at least one layer of mix to obtain a hardened slab having a surface layer and a main body in which the veins are formed, machining of visible surface of the surface layer by means of sizing and/or smoothing and/or polishing, application of a disperse ink containing pigments at least on the machined surface and drying of the disperse ink and penetration, by means of diffusion, of the pigments of the disperse ink in the slab by means of a phase transition so as to produce the chromatic effects.

The present invention relates to the technical field for the production of articles made of stone or stone-like agglomerate material and concerns in particular a method for manufacturing slabs having veins and surface chromatic effects.

The invention also relates to a plant for manufacturing slabs of the type described above and a slab thus obtained.

In the technical field relating to the production of articles and slabs made of stone or stone-like agglomerate material, the agglomerate is obtained by means of compaction, preferably by means of vacuum vibro-compression, and hardening of at least one mix. The mix contains mainly a binder and granules and/or powders of stone or stone-like material.

In particular, the granules and powders generally consist of natural minerals which may be of a siliceous nature, such as quartz, granite, porphyry, basalt, quartzites, silica sands, or of a calcareous nature, such as marbles, dolomite, coloured stones, etc. Alternatively, the granules and powders may consist of synthetic minerals.

Alternatively or in addition, the mix may also contain granules and/or powders of expanded material, such as expanded glass or expanded clay.

Furthermore, the binder is preferably of an organic type and consists of a hardening resin chosen from the group comprising polyester resins, acrylic resins, epoxy resins, polyurethane resins, but also resins of natural and plant origin. As an alternative to the organic binding resin, a cementitious hydraulic binder may be used.

The mix may also contain fillers, further binders, additives and dyes. In particular, the mineral fillers are materials used in combination with the resin in order to form the so-called binding paste.

The fillers generally consist of natural or synthetic stone materials of various kinds, which are finely ground, such as ventilated silica or ventilated feldspar for the agglomerates formed with siliceous aggregates, and calcium carbonate or aluminium hydroxide for the agglomerates formed with calcareous aggregates.

The slabs of agglomerate material, which are made as indicated above, may also undergo a step involving the application or printing of an ink containing pigments, preferably a disperse ink and/or sublimation ink, on at least one of the surfaces and penetration by means of diffusion of the pigments into the surface layer of the slab in order to form decorations and/or chromatic effects with predefined patterns.

In the context of the present description, the expression “disperse ink” is understood as meaning an ink in which the pigments are intended to undergo a phase transition from the solid state to the liquid/gaseous state or from the liquid state to the gaseous state owing to the action of a heat source and/or the application of a predetermined pressure, the phase transition being advantageously used in order allow the penetration by means of diffusion into the surface layer of the mixes of the slabs.

Furthermore, in the context of the present description, the expression “sublimation ink” is understood as meaning an ink in which the pigments are intended to undergo sublimation, passing from the solid state to the gaseous state as a result of the action of a heat source and/or the application of a predetermined pressure in order to allow the aforementioned penetration by means of diffusion into the surface layer of the mixes of the slabs.

The sublimation ink constitutes a specific type of disperse ink; therefore, in the continuation of the present description and where not otherwise indicated, reference will be made for the sake of convenience only to disperse ink.

The pigments are dispersed in a preferably aqueous solution and the phase transition favours the penetration, by means of diffusion, of the pigments into the surface layer of the mix or the slab.

In particular, following the phase transition, the pigments in the inks penetrate by means of diffusion into the binding resin, namely the organic component of the mix, over a thickness of a few tenths of a millimetre.

In the technical field of the present invention, in order to apply the disperse ink onto at least one surface of the slab or onto the mix in an effective manner and with an attractive aesthetic effect, the mix and/or the slab must have at least the following characteristics:
a light pigmentation of the granules and/or powders, preferably white or slightly coloured with light shades or transparent;
a small particle size of the granules and/or the powders, preferably ranging between 0.1 mm and 0.3 mm.

The decorations and/or the chromatic effects realized by means of application and penetration of the disperse ink generally consist of images or patterns or reproductions of a natural stone with veining and resemble all the more closely the appearance of natural stone the greater the number of pixels in the image or pattern or reproduction to be printed.

Furthermore, the application of the disperse ink or sublimation ink onto at least one surface of the mix and/or of the slab may be performed in two different ways, namely:
using a sheet having the decoration pre-printed thereon with the ink to be subsequently applied onto the surface of the slab; or
directly applying the ink onto the surface of the slab or onto the mix.

The first method of application and penetration by means of diffusion of the pigments is used preferably with sublimation ink and involves essentially the following steps:
printing the decoration with the sublimation ink on a sheet, also called sublimation sheet;
depositing the sublimation sheet on a surface of the slab which has been machined (smoothed, polished, sized, etc.) and is intended to remain visible;
inserting the slab and the sublimation sheet into a hot press in order to perform the sublimation of the sublimation ink with the resultant transfer of the decoration and/or the chromatic effect from the sheet to the material of the slab;
cooling the slab to room temperature.

The second operating method instead involves the formation of the decoration and/or the chromatic effect directly on the surface of the slab or on the mix by applying the disperse ink or sublimation ink by means of digital inkjet printers or plotters, for example, and heating the slab or mix with the ink to a predetermined temperature.

Examples of this second operating method are known, for example, from the patent documents US2020/0262101 and WO2021/053596.

US2020/0262101 discloses a method for manufacturing articles and slabs made of engineered stone and having decorations printed on at least one surface. The method comprises the following steps:
providing a base mix and dispensing, as required, a colouring agent in the mix;
vacuum vibro-compression of the mix;
hardening of the mix;
machining of the article.

The method also involves a step of application of an ink onto at least one surface of the article or the slab in order to provide the chromatic effects, this application step being performed alternatively:
before vacuum vibro-compression of the mix;
between vibro-compression and hardening of the mix;
between hardening of the mix and machining of the article.

This latter embodiment also envisages a step involving hardening of the chromatic effect formed with the ink, this step being performed at the same time as hardening of the mix or at a different time.

Therefore, the application of the ink may be carried out on the fresh mix to be compacted or on the compacted mix or on the article following hardening of the mix.

The method disclosed in US2020/0262101 may also comprise a further step of application of a protective coating onto the article or slab in order to improve the wear and scratch resistance thereof and provide the article or slab with anti-microbial properties.

The protective coating may be formed by a filler, for example corundum, silver or titanium oxide, and by a hardening resin, for example an epoxy resin or acrylic resin.

WO2021/053596 discloses a plant for the production of slabs made of agglomerate material from a mix of the type indicated above.

The plant further comprises both means for distributing a mixture in the mix in order to form veining and application means for applying a disperse ink.

In particular, the application of the disperse ink is performed on the compacted mix, i.e. before hardening of the mix.

The ink application means consist of a digital printer provided with a plurality of movable heads designed to allow penetration of the ink into the compacted mix over a thickness of between 3 cm and 4 cm.

After performing the compaction step, in a manner similar to that described above for US2020/0262101, the mix is preheated to a temperature of between 30° C. and 60° C. in order to favour the penetration of the disperse ink in the mix which will be subsequently deposited.

The subsequent mix hardening step is performed by means of heating to a temperature of between 100° C. and 150° C.

The technical solutions described above are not without certain drawbacks.

A first drawback consists in the fact that the subsequent machining operations carried out on the surface of the article or the slab onto which the disperse ink has been applied tend to remove the superficial layers of material and therefore part of the chromatic effect previously realized.

A further drawback consists in the fact that the protective coating, where provided, also tends to be at least partially removed following machining of the article or the slab.

Therefore, this drawback results in less resistance of the article or slab to wear and scratches.

Another drawback consists in the fact that the disperse ink applied onto the slab may be removed at least partially if it comes into contact with particularly aggressive solvents.

Italian patent application 102022000000026 also discloses a method for the production of slabs with decorations and/or chromatic effects on their surface, said method involving the direction application of the disperse ink onto a machined surface of the hardened slab, drying of the ink, the action of a heat source and/or the application of a pressure in order to cause the penetration, by means of diffusion, of the pigments of the ink and the application of a protective functional compound onto the surface of the slab. This method, while being widely recognised in the field, is unable however to produce slabs in which the surface decorations and/or chromatic effects, although clear and well-defined, are present in a uniform manner, and therefore clearly visible, throughout the thickness of the slabs.

This drawback is due to the limited depth of penetration of the disperse ink and is particularly evident along the edges of the slabs, namely in the zones where the slabs undergo one or more machining processes, such as longitudinal or transverse cutting or polishing of the edge, which affect the thickness thereof.

The slabs thus obtained may therefore be easily distinguished from the slabs provided with veining only and made of natural stone material.

The main object of the present invention is therefore to provide a method and a plant for manufacturing slabs of stone or stone-like agglomerate material having veins and/or surface chromatic effects and a slab thus obtained, which are able to overcome the aforementioned drawbacks.

A particular task of the present invention is to provide a method of the type described above which is able to provide slabs in which the surface chromatic effects and the veining formed in the thickness have corresponding predefined patterns and/or are aesthetically compatible.

Another task of the present invention is to provide a method of the type described above which is able to provide slabs which have an aesthetic pattern which is uniform both on the surface and in the thickness.

A further task of the present invention is to provide a method of the type described above which allows the manufacture of slabs of agglomerate material which resemble as closely as possible the slabs made of natural stone material.

Another task of the present invention is to provide a method of the type described above in which the surface chromatic effects formed in the surface layers of the slabs are well-defined, pronounced and clearly visible.

Another task of the present invention is to provide a method of the type described above which allows the manufacture of slabs with chromatic effects which last over time.

Another task of the present invention is to provide a method of the type described above which reduces significantly the risk of removal or elimination of the chromatic effects from the surface of the slab on which they are formed.

A further task of the present invention is to provide a method of the type described above which allows the manufacture of slabs with a high resistance to wear, scratches and solvents.

Another task of the present invention is to provide a plant of the type described above which is simple and has limited production costs.

Another task of the present invention is to provide a slab which has a uniform aesthetic effect very similar to the effect of the natural stone provided with veining, as well as clear and well-defined chromatic effects.

The object and the main tasks described above are achieved with a method and plant for manufacturing slabs of stone or stone-like agglomerate material having veins and surface chromatic effects in accordance with Claim 1 and Claim 25, respectively, and a slab thus obtained in accordance with Claim 31.

In order to illustrate more clearly the innovative principles of the present invention and its advantages compared to the prior art, at least one example of embodiment of the plant according to the present invention and of a slab obtained by means of the method and the plant of the present invention will be described below with the aid of the attached drawings. In particular, in the figures:

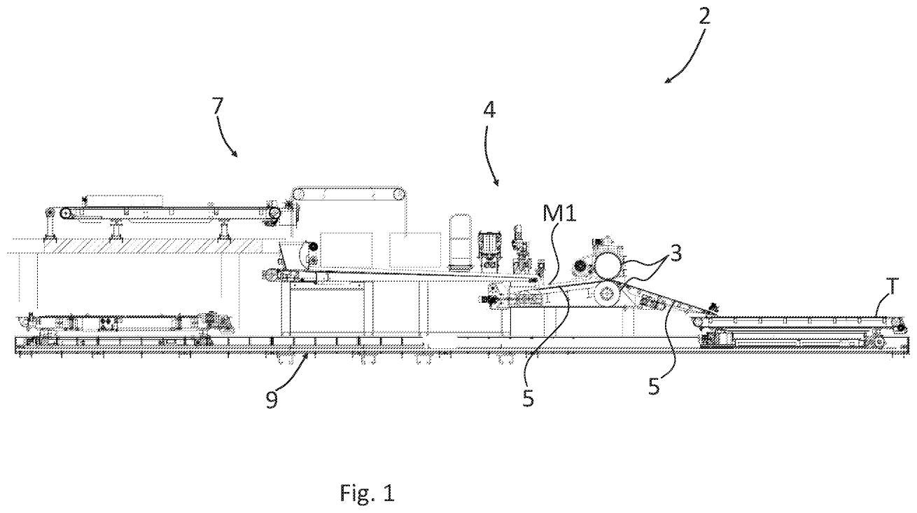

FIG. 1 is a front view of a station for distribution of a mix in accordance with a first embodiment;

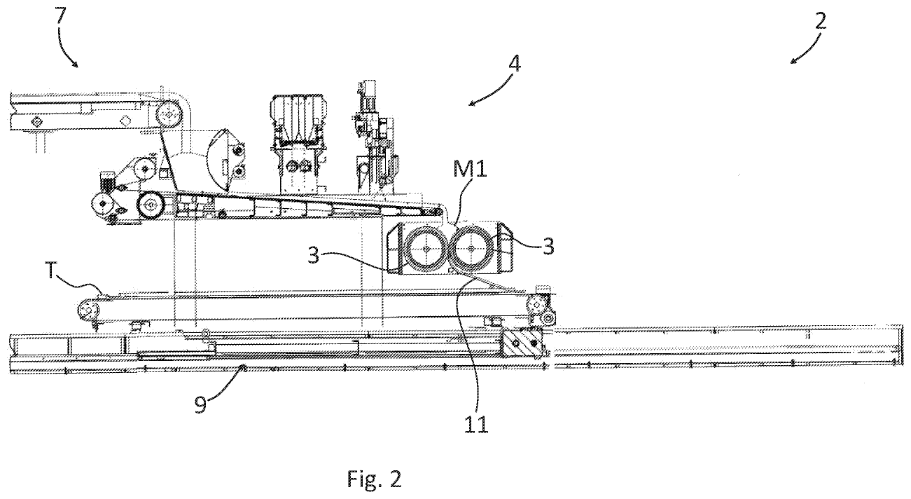

FIG. 2 is a front view of a station for distribution of a mix in accordance with a second embodiment;

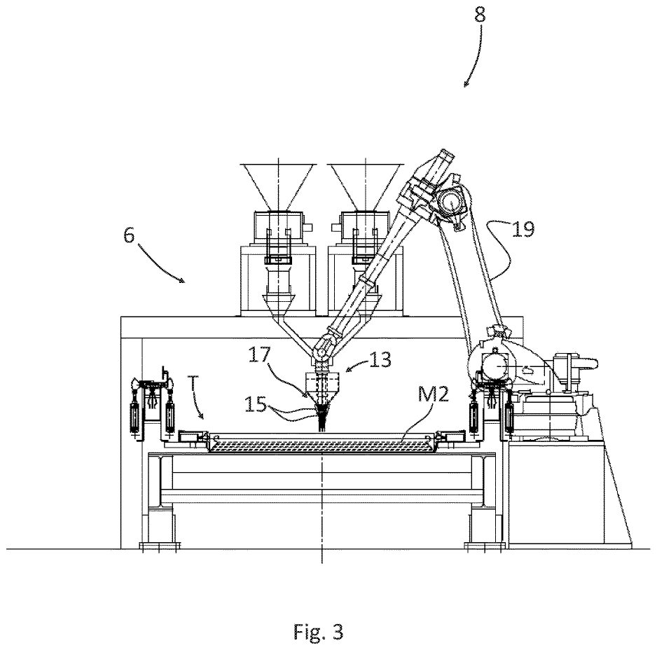

FIG. 3 is a side view of station for the formation of veins in a mix in accordance with a first configuration;

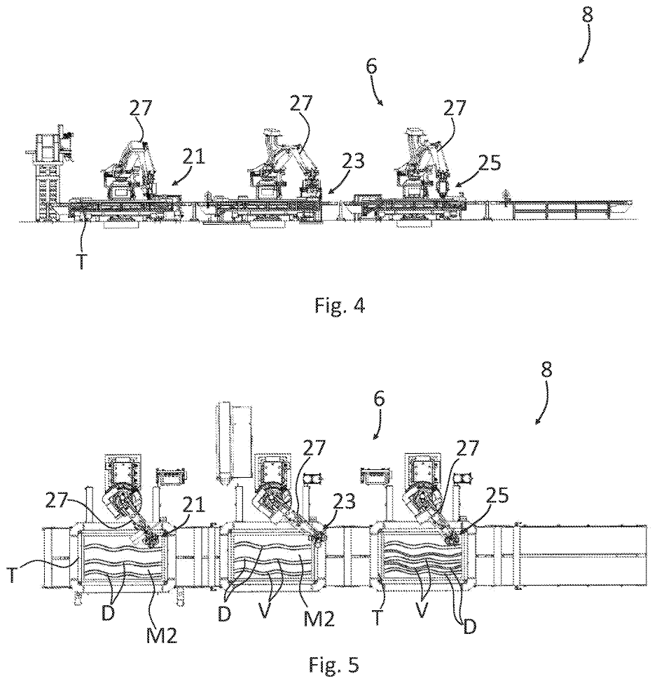

FIG. 4 is a front view of station for the formation of veins in a mix in accordance with a second configuration;

FIG. 5 is a top plan view of the station for forming the veins shown in FIG. 4;

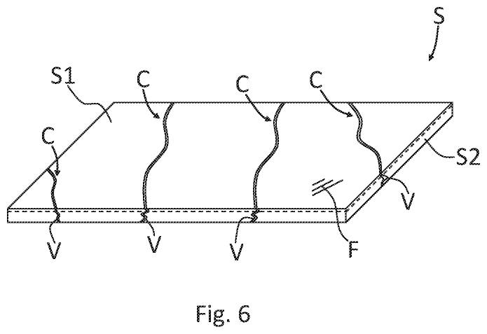

FIG. 6 shows a schematic perspective view of a slab according to the present invention.

The present description, provided solely by way of a non-limiting illustration of the scope of protection of the invention, relates to a method and a plant for manufacturing slabs of stone or stone-like agglomerate material having veins and/or surface chromatic effects formed on at least one of the surfaces of the slabs, and a slab thus obtained. The slabs are obtained from at least one mix or from mixes comprising a binding resin and granules and/or powders of stone or stone-like material, intended to form aggregates, as described further below.

The chromatic effects C, or decorations, are preferably produced using a disperse ink, in particular an ink comprising pigments which are intended to undergo a change in state from the solid to liquid/gaseous state or from the liquid state to the gaseous state as a result of the action of a heat source and/or the application of a predetermined pressure. Such a disperse ink is particularly resistant both to chemical agents and to UV rays.

The chromatic effects may also be realized by means of a sublimation ink, namely an ink in which the pigments are intended to undergo sublimation, changing from the solid state to the gaseous state owing to the action of a heat source and/or the application of a predetermined pressure.

The pigments of the disperse ink penetrate, by means of diffusion, into the slab S, in particular in the zones or portions of a surface layer S1 of the slab S in which the binding resin is present, as a result of the phase transition, to a depth of a few tenths of a millimetre, hence at least partially into the thickness of the slab L.

Generally, the pigments of the disperse ink penetrate into the surface layer S1 of the slab S to a depth of about 300 μm.

In the case of a sublimation ink, the penetration into the surface layer S1 of the slab S occurs following sublimation of the pigments of the ink.

As shown in FIG. 6, the surface chromatic effects C, or decorations, are generally formed by a pattern or an image of a natural stone provided with veining so that the slabs S of agglomerate material resemble as far as possible slabs of natural stone material. The granules and the powders of the mixes generally consist of natural minerals which may be of a siliceous nature, such as quartz, granite, porphyry, basalt, quartzites, cristobalite, silica sands, or of a calcareous nature, such as marble, dolomite, coloured stones, etc. Alternatively, the granules and powders may consist of synthetic minerals.

Furthermore, the granules and powders may have a varied particle size, depending on the aesthetic appearance and/or the physical/mechanical properties which are to be obtained in the finished slabs.

Alternatively or in addition, the mixes may also contain granules or powders of expanded material, such as for example expanded glass or expanded clay.

Furthermore, the binder is preferably of an organic type and consists of a hardening resin chosen for example from the group comprising polyester resins, acrylic resins, epoxy resins, polyurethane resins, but also resins of natural and plant origin. As an alternative to the organic binding resin a cementitious binder may be used.

The mixes may also contain fillers, further binders, additives and dyes. In particular, the mineral fillers are materials used in combination with the resin in order to form the so-called binding paste.

As further described below and as shown in FIG. 6, the actual veins V are formed in the thickness, i.e. in the central body S2 of the slabs S integral with the surface layer S1 of the slab S or coupled thereto, using at least one liquid or powder dye and/or at least one colouring mix D.

The method comprises mainly the following steps:
distribution on the temporary support T of at least one layer of mix M1, M2 comprising a binding resin;
formation of the veins V in the at least one layer of mix M1, M2;
compaction of the at least one layer of mix M1, M2 distributed on said temporary support T;
catalysis of the binding resin of the mix M1, M2;
cooling of the at least one layer of mix M1, M2 so as to obtain a hardened slab S with the surface layer S1 and the main body S2 in which the veins V are formed;
machining of the visible surface of the surface layer S1 of the slab S by means of sizing and/or smoothing and/or polishing;
application of a disperse ink containing pigments at least on the machined surface and drying of the disperse ink;
penetration, by means of diffusion, of the pigments of the disperse ink into the surface layer S1 of the slab S by means of a phase transition so as to produce the chromatic effects C;
optional application of a layer of functional compound F at least onto the machined surface of the slab S with the chromatic effects C.

The method for manufacturing slabs S made of stone or stone-like agglomerate material and having veins V and surface chromatic effects C in this case involves the use of two mixes M1 and M2 and comprises the following steps:
distribution of a layer of a mix M1 on a temporary support T;
distribution of a layer of an additional mix M2 on the temporary support T so as to form a sandwich arrangement or a multilayer intermediate machining product;
formation of veins V in the layer of the additional mix M2;
compaction of the sandwich arrangement of mixes M1, M2 which are distributed on the temporary support T and which will form the monolithic slab S;
catalysis of the binding resins of the mixes M1, M2;
cooling of the sandwich arrangement of mixes M1, M2 so as to obtain a hardened slab S in which a surface layer S1 is formed by the layer of mix M1 and the main body S2 is formed by the layer of additional mix M2 with the veins V;
machining of the visible surface, i.e. of the surface layer S1 of the slab S, by means of sizing and/or smoothing and/or polishing;
applying a disperse ink containing pigments at least on the machined surface;
drying the disperse ink;
penetration, by means of diffusion, of the pigments of the disperse ink into the surface layer S1 of the slab S by means of a phase transition of the pigments so as to produce the corresponding chromatic effects C;
optional application of a layer of functional compound F at least onto the machined surface of the slab S with the chromatic effects C.

Therefore, the slabs L may be obtained from a single mix M1, M2 distributed in the temporary support T so as to form a single layer or from a pair of layers of mixes M1, M2 deposited at different times.

In this embodiment, the layer of additional mix M2 is distributed on top of the layer of mix M1; alternatively, the step involving distribution of the layer of mix M1 may be performed following the step for distribution of the additional mix M2 and the step for formation of the veins V.

The layers of mixes M1, M2 may be formed from the same type of mix having a single volumetric or weight content of binding resin and a single colour.

Alternatively, should the mixes M1, M2 be different, the volumetric or weight content of binding resin may be similar for the two mixes M1, M2, preferably equal to about 25% of the overall weight of the mixes, so as to avoid warping of the slabs during the catalysis and cooling step and the colouring of the two mixes M1, M2 may be the same or different; furthermore, the thicknesses of the respective layers may be different.

In accordance with this latter embodiment, the granules and/or powders of stone or stone-like material of the mix M1 have a light-coloured, preferably white, pigmentation so that the chromatic effects C formed in the surface layer S1 with the disperse ink are clear and well-defined.

In this connection, the material of the granules and powders of the mix M1 is preferably quartz or cristobalite and/or a synthetic mineral containing calcium silicate crystals.

Furthermore, the granules and/or powders of stone or stone-like material of the mix M1 have preferably a grain size of between 0.1 mm and 0.3 mm.

The surface layer S1 of the hardened slab S, which may be formed by the layer of mix M1 and comprises the granules and/or powders described above, therefore also has a pigmentation with light shades and preferably white pigmentation.

The additional mix M2 is plain-coloured or is varyingly coloured, also before formation of the veins V therein.

The distribution of the at least one layer of mix M1, M2, namely of the layer of mix M1 and the layer of additional mix M2, is performed by means of respective stations 2 comprising means 4 for distributing the mixes.

In particular, the distribution of the at least one layer of mix M1 is performed preferably by means of rolling of the mix and the distribution means 4 are of the type described in the patent application WO2020/058834 and shown by way of example in FIGS. 1 and 2. Said distribution means 4 will be further described below with reference to the plant. The step involving distribution of the layer of additional mix M2 may also be performed by means of rolling of the mix, using the distribution means 4 described above.

Alternatively, the step of distribution of the layer of additional mix M2 may be performed by a traditional weighing dispenser, not shown in the attached figures, without rolling means.

Conveniently, the surface layer S1 of the hardened slab S has a smaller thickness than the thickness of the main body S2 of the hardened slab S.

In particular, the layer of mix M1 and the surface layer S1 of the hardened layer S have smaller thicknesses than the thickness of the layer of additional mix M2 and therefore the thickness of the main body S2 of the hardened layer S, as shown more clearly in FIG. 6

The thickness of the layer of mix M1 has a value preferably not greater than 3 mm and the thickness of the corresponding surface layer S1 in the hardened slab S and, after the surface machining step, has a value preferably not greater than 1 mm.

Said thickness value of the surface layer S1 is the smallest which can be obtained using the machining means known from the state of the art and is such that the separation from or difference with respect to the main body S2 of the slab S is not visible to the naked eye.

In this connection it is pointed out that in the attached FIG. 6 the separation between the surface layer S1 and the main body S2 is highlighted schematically by means of a broken line; however, as described above, said separation in reality cannot be easily discerned by the naked eye.

As already mentioned, the veins V in the at least one layer of mix M1, M2 or in the layer of additional mix M2 may be realized by means of deposition of a liquid or powder dye or a colouring mix D different from the at least one mix M1, M2 or from the additional mix M2.

Advantageously, the liquid or powder dye may be distributed inside grooves formed in the at least one layer of mix M1, M2 or in the layer of additional mix M2 or may be distributed on the at least one layer of mix M1, M2 or on the layer of additional mix M2 and then mixed with it.

The dye formed by the colouring paste D is solely distributed inside grooves formed in the at least one layer of mix M2 or in the layer of additional mix M2.

The step of formation of the veins V may be performed by suitable means 6 for formation of the veins in the at least one layer of mix M1, M2 or in the layer of additional mix M2 of the type described in patent application WO2020/115644 and WO2016/113652.

These means 6 for formation of the veins are shown by way of example in FIGS. 3, 4 and 5 and will be described again in detail below with reference to the plant for manufacture of the slabs S.

Alternatively, in accordance with an embodiment not shown in the attached figures, the step of formation of the veins V may also be performed manually by one or more operators, with the aid, as required, of suitable devices, such as templates known in the field and/or projectors for projecting onto the mixes images corresponding to the veins V to be formed.

As shown in FIG. 6, the chromatic effects C, namely the veins and the surfaces designs, are formed with the disperse ink on the surface of the surface layer S1 of the slab S.

In particular, the chromatic effects C and/or the veins of the chromatic effects C are formed with a predefined pattern corresponding to and/or aesthetically compatible with a predefined pattern of the veins V, optionally formed in the layer of additional mix M2, namely in the thickness of the main body S2 of the slab S.

In this way there is no discontinuity between the surface veins of the chromatic effect C and the veins V obtained with the dye or with the colouring mix D and the slab S thus obtained appears, to all intents and purposes, to be made of natural stone material with the veins distributed uniformly throughout its thickness.

The compaction step, preferably performed by means of vacuum vibro-compression, of the at least one mix M1, M2 or sandwich arrangement of mixes M1, M2, the step for catalysis of the binding resins and the cooling step for obtaining the hardened slabs S are performed in accordance with the known Bretonstone® method and using devices and machines which are known in the field.

The machining step involving sizing and/or polishing and/or smoothing is carried out on the visible surface of the hardened slab using machines, devices and tools of the known type, for example using abrasive tools mounted on rotating heads, not shown in the attached figures.

The disperse ink is applied onto the machined surface and penetrates by means of diffusion into the surface layer S1 of the hardened slab S over a depth with a value as indicated above.

The step of applying the disperse ink may be carried out by applying directly the disperse ink onto the surface of the machined slab by means of digital inkjet printers or plotters and may be performed on defined portions of the surface of the slab S or over the entire surface of the slab S to be decorated, depending on the type of chromatic effect to be obtained.

Alternatively, the step of applying the disperse ink onto the surface of the slab S may be carried out by arranging on the machined surface of the slab a sheet, also known as sublimation sheet, which has the chromatic effect C pre-printed thereon with the disperse ink to be then applied onto the surface of the slab S.

The disperse ink consists preferably of a dispersion of pigments in a solution, which is preferably aqueous, and is applied onto the at least one surface of the slab or onto the sublimation sheet in liquid form.

If the method for manufacturing the slabs involves the distribution of the mix M1 before distribution of the additional mix M2 and is performed continuously, the compacted hardened slab S, once extracted from the temporary support T, must be overturned before proceeding with the further steps and, in particular, with the application of the disperse ink onto the surface layer S1.

Alternatively, at the end of the catalysis and cooling steps, the hardened slab S with the veins V may be removed and suitably stored. In order to proceed with the formation of the surface chromatic effects C, the slab S is again taken out of storage and positioned with the surface layer S1 visible so as to allow the application of the disperse ink thereon. The application step of the disperse ink may be preceded by a step involving the application and drying of a primer so as to form a film on the machined surface of the slab S.

Preferably, the primer consists of a solution or dispersion-preferably aqueous-of organic and/or inorganic compounds compatible with the process involving direct application of the disperse ink onto the slab S.

Again more preferably, the primer consists of an organic compound solution or dispersion intended to form the film following drying.

In this embodiment, the disperse ink is applied onto the film formed by the dried primer and then undergoes itself the drying step.

The primer has the function of promoting adhesion of the disperse ink and preventing the uncontrolled diffusion thereof over the surface of the slab S, thus avoiding a reduction in chromatic yield and definition of the decoration.

The step of drying the disperse ink, performed after application of the ink and before penetration by means of diffusion of the pigments, may be carried out in an oven at a temperature of between 85° C. and 95° C. and for a duration of between 2 and 20 minutes.

Alternatively, the drying step may be performed in a hot-air oven at a temperature close to 110°-120° C. and for a time period of about 60 minutes. This latter operating mode allows the slabs to be heated to a temperature close to 100° C.

The drying step carried out using the methods described above is able to eliminate the volatile compounds from the-preferably aqueous-solution of disperse ink applied onto the visible surface of the slab S, or onto the film formed by the primer.

In this way, the dried disperse ink forms, in combination with the primer, a kind of film on the surface of the slab to be decorated, this film having a function similar to the function of the sublimation sheet described above.

As mentioned, during penetration by means of diffusion, the pigments of disperse ink are intended to undergo a phase transition from solid to liquid/gaseous or from liquid to gaseous following the action of a heat source and/or the application of a predetermined pressure.

In the embodiment which envisages the use of a sublimation ink, the diffusion penetration step is performed by means of sublimation of the pigments of the sublimation ink, namely by means of the change from the solid state to gaseous state as a result of the action of a heat source and/or the application of a predetermined pressure. In the present invention, the step involving penetration, by means of diffusion, of the dried sublimation ink and/or disperse ink is performed in an oven, preferably a hot-air oven.

If the drying step is performed at a temperature of between 85° C. and 95° C. as described above, the hot-air oven for performing the ink diffusion penetration step is kept at a temperature of between 140° C. and 220° C. for a time period of between 5 and 30 minutes.

Alternatively, if the drying step is performed at a temperature close to 110° C. -120° C. as described above, the hot-air oven for performing the ink diffusion penetration step is kept at a temperature close to 200° C. for a time period of between 10 and 15 minutes.

The execution of the drying step at a temperature close to 110°-120° C., which allows the slabs to be heated to a temperature close to 100° C. at the end of the drying step, allows small-size hot air ovens to be used in order to carry out the diffusion penetration step.

The execution of the steps involving application and drying of the disperse ink and penetration of the pigments is able to avoid or limit the removal of the chromatic effects C from the surface during any further machining of the slab S.

Following penetration of the pigments by means of diffusion and before application of the functional compound F there is a further cooling step which must be carried out avoiding heat shocks and/or deformations which affect the slab.

In order to prevent this, said cooling step is preferably performed using air at room temperature and has a duration of at least 60 minutes.

The aforementioned measures help ensure the penetration of the ink pigments into the surface layer S1 of the slab S1 in the zones where the resin is present following the phase transition, in particular following liquefaction/sublimation/evaporation, of the inks.

Advantageously, the method also comprises a step for removal of the excess ink which is carried out after the further cooling step, preferably by brushing with abrasive tools at least one surface of the slab S.

Conveniently, the step of application of the layer of functional compound F onto the at least one surface of the slab S is performed at least after the step of penetration of the pigments, namely after the step of penetration of the ink by means of diffusion.

In particular, the step of application of the functional compound F is performed after both the penetration and cooling steps and the step for removal of the excess disperse ink.

Preferably, the functional compound F is transparent and consists of a solution of silazane in a solvent; silazane is an organometallic compound consisting of nitrogen-containing silane having a linear or branched chain of silicon, nitrogen and carbon atoms joined by covalent bonds.

The functional compound F of the type indicated above, after being applied onto the surface of the slab on which the chromatic effect C has been formed, is allowed to dry and harden so as to form a layer having a thickness of a few microns; said layer contains nanoparticles of quartz bonded covalently to the functional groups on the surface of the slab.

In particular, in the slab S according to the present invention obtained from the at least one mix M1, M2 or mixes M1, M2 described above, the silazane solution is stably bonded both to the granules of silica and calcium silicate and to the organic component of the resin and the ink.

In the technical field of the present invention the silazane solution allows the slabs to be made more resistance to wear, treading, chemical agents, solvents, scratches and adverse weather.

Therefore the functional compound F formed by the silazane solution has a protective function, namely it acts as a protective compound, allowing the use of the slab obtained with the method according to the present invention for preparation of flooring, external cladding, kitchen worktops or other products which are normally subject to wear.

In addition to the protective function, the silazane solution also helps confer a greater shininess to the surface of the slab onto which it is applied.

Furthermore, the method may comprise, before application of the layer of functional compound F, a step of polishing the surface of the slab onto which the functional compound F will be applied, using fine-grain polishing tools.

The latter step allows removal of the surface layer from the surface of the slab S, at least over a thickness of a few microns, and becomes necessary because heating of the slab to 220° C. during the following diffusion penetration step may deteriorate the surface state S1 of the slab S, with a reduction in the shininess thereof.

As mentioned, the present invention also relates to a plant for manufacturing slabs of stone or stone-like agglomerate material with veins V and surface chromatic effects C. The plant comprises preferably:
at least one station 2 comprising means 4 for distributing, on a temporary support T, the at least one layer of mix M1, M2 comprising a binding resin;
a station 8 comprising means 6 for the formation of veins V in the at least one layer of mix M1, M2;
a station comprising means for compaction of the at least one layer of mix M1, M2 distributed on the temporary support T;
a station comprising means for performing catalysis of the binding resin of the at last one mix M1, M2;
a station comprising means for cooling the at least one layer of mix M1, M2 so as to obtain a hardened slab S with a surface layer S1 and a main body S2;
a station comprising means for machining the surface of the slab S by means of sizing and/or smoothing and/or polishing of the visible surface of the slab S;
a station comprising means for the application, drying and penetration by means of diffusion of a disperse ink containing pigments on the machined surface of the slab S so as to provide the surface chromatic effects C.

In the case where two mixes M1 and M2 are used, the plant for manufacturing slabs S made of stone or stone-like agglomerate material and having veins V and surface chromatic effects C comprises:
a station 2 comprising means 4 for distributing the layer of mix M1 on the temporary support T;
a station 2 comprising means 4 for distributing the layer of additional mix M2 on the temporary support T in order to form the sandwich arrangement;
a station 8 comprising means 6 for the formation of veins V in the layer of additional mix M2;
a station comprising means for compaction of the sandwich arrangement of mixes M1, M2 which are distributed on the temporary support T and which will form the slab S;
a station comprising means for performing catalysis of the binding resins of the mixes M1, M2;
a station comprising means for cooling the sandwich arrangement so as to obtain a hardened slab S with the surface layer S1 corresponding to the layer of mix M1 and the main body S2 corresponding to the layer of additional mix M2;
a station comprising means for machining by means of sizing and/or smoothing and/or polishing the visible surface layer S1 of the hardened slab S;
a station comprising means for the application, drying and penetration by means of diffusion of a disperse ink containing pigments on the machined surface of the slab S so as to provide the surface chromatic effects C on said surface;
an optional station comprising means for the application of a layer of functional compound F on the surface of the slab S.

In accordance with this latter embodiment, the station for distribution of the mix M1 may also be located downstream of the station for distribution of the additional mix M2 and the station for formation of the veining V.

The stations 2 for distribution of the mixes M1, M2, may be the same or different from each other or may comprise distribution means 4 which are the same or different from each other.

Two alternative embodiments of the station 2 for distribution of the mix M1 and if necessary the station 2 for distribution of the additional mix M2 are shown in FIG. 1 and FIG. 2, respectively. As mentioned, these embodiments are described in the patent application WO2020/058834.

In both these embodiments, the means 4 for distributing the mixes M1, M2 consist of rolling means comprising mainly a pair of rollers 3 which have the respective axes of rotation horizontal and vertically offset and positioned one above the other (see FIG. 1) or horizontal and offset along the direction of feeding of the mix (see FIG. 2).

The first embodiment also comprises intermediate supporting conveyor belts 5 for conveying the mix from the mix feeding means 7 to the rollers 3 and from the rollers 3 to the temporary supports T with a relative advancing movement by means of respective movement means 9.

The second embodiment comprises a conveyor element 11 for conveying the mix having a shaped profile and positioned downstream and in a position underneath the rolling rollers 3.

Obviously, the stations 2 for distribution of the mixes M1, M2 may also have a configuration different from that described above, without departing from the scope of protection of the present invention.

Furthermore, FIGS. 3 and 4 show alternative configurations of the means 6 for formation of the veins V in the at least one layer of mix M1, M2 or in the layer of additional mix M2 distributed beforehand on the temporary support T.

In the first configuration said means 6 comprise a device 13 for distributing the dye, namely a hopper for discharging a powder dye and/or nozzles 15 for spraying a liquid dye.

Said distribution device 13 further comprises a tool 17 intended to interact mechanically with the at least one layer of mix M1, M2 or with the layer of additional mix M2 in order to form grooves inside which the dye is distributed or in order to perform mixing of the mix on which the dye is distributed.

The distribution device 13 is mounted on suitable movement means, such as an anthropomorphic robot 19, for relative moment with respect to the advancing surface of the temporary support T containing the mix or mixes M1, M2.

The second configuration shown in FIG. 4 comprises preferably a first station with head 21 having a grooving tool for forming grooves in the at least one layer of mix M1, M2 or in the layer of additional mix M2, a second station with a head 23 comprising a container for distribution of a colouring mix D in the grooves and a third station with a head 25 comprising a grooving tool and a container for distribution of a further colouring mix D.

The first, second and third stations generally comprise anthropomorphic arms 27 which move the respective heads 21, 23 and 25.

As already mentioned, the veins V may also be realized manually by one or more operators with the aid, where necessary, of suitable devices, such as templates known in the field and/or image projectors.

The stations for sizing and/or smoothing and/or polishing the surface of the superficial layer S1 of the hardened slab S and the respective means such as, for example, abrasive tools mounted on respective rotating heads, are not shown in the attached figures.

The stations for performing the compaction of the mixes, the catalysis of the binding resin and the cooling of the mixes may preferably consist of the stations commonly used to perform the Bretonstone® methods and as such will not be further described in the present description.

As already mentioned, the means for application of the disperse ink may comprise digital printers or plotters, not shown in the attached figures, while the means for drying and penetration of the ink may comprise preferably hot-air ovens, which are also not shown in the attached figures.

The means for application of the layer of functional compound may comprise, for example, one or more nozzles and are not shown in the attached figures.

The plant may also comprise a station for application of the primer described above onto the corresponding surface of the slab and means for feeding and/or picking up the temporary supports T containing the mix or mixes M1, M2 and/or the slabs S between the various stations.

Furthermore, the plant comprises a control unit, not shown in the attached figures, which has installed software and is connected to the various stations.

In particular, the means 6 for formation of the veins V and the means for application of the disperse ink are controlled by the control unit (in terms, for example, of the trajectories to be followed) so that the veins V of the main body S2 of the slabs S and the chromatic effects C, namely the surface veins, are realized with predefined patterns which correspond to each other and have a compatible aesthetic effect, taking into account also the retraction of the mixes which occurs during the catalysis step.

The operation of the control unit may also take advantage of suitable sensors located in the plant and configured to detect the position and/or the distribution and/or the form of the veins V and transmit this information to the control unit which processes it for the subsequent formation of the chromatic effects C.

The software of the control unit may also comprise at least one artificial intelligence algorithm.

From the above description it is now clear how the method and the plant for manufacturing slabs with veins in the slab body and surface chromatic effects, as well as the slab thus obtained, are able to achieve advantageously the predefined objects.

In particular, the measures described above are able to obtain a uniform aesthetic effect on the slab very similar to the effect of natural stone provided with veining.

Furthermore the slabs thus obtained have surface chromatic effects, namely surface veins, which are clear and well-defined and have a high resistance to abrasion and solvents.

Obviously, the above description of embodiments applying the innovative principles of the present invention is provided by way of example of these innovative principles and must therefore not be regarded as limiting the scope of the rights claimed herein.

1. A method for manufacturing slabs made of stone or stone-like agglomerate material and having veins and surface chromatic effects, which method comprises the following steps:
distribution on a temporary support of at least one layer of mix comprising a binding resin;
formation of the veins in the at least one layer of mix;
compaction of the at least one layer of mix distributed on said temporary support;
catalysis of the binding resin of the mix;
cooling of the at least one layer of mix in order to obtain a hardened slab with a surface layer and a main body in which said veins are formed;
machining of the visible surface of the surface layer of said slab by means of sizing and/or smoothing and/or polishing;
application of a disperse ink containing pigments at least on said machined surface and drying of said disperse ink; and
penetration, by means of diffusion, of the pigments of the disperse ink into the surface layer of the slab by means of a phase transition so as to produce said chromatic effects.

2. The method according to claim 1, further comprising the following steps:
distribution of a layer of a mix on a temporary support;
distribution of a layer of an additional mix on said temporary support so as to form a sandwich arrangement;
formation of veins in the layer of additional mix;
compaction of the sandwich arrangement of mixes distributed on said temporary support;
catalysis of the binding resins of the mixes;
cooling of the sandwich arrangement so as to obtain a hardened slab in which a surface layer is formed by the layer of mix and the main body is formed by the layer of additional mix;
machining of the visible surface of the surface layer of said slab by means of sizing and/or smoothing and/or polishing;
application of a disperse ink containing pigments at least on said machined surface and drying of said disperse ink; and
penetration, by means of diffusion, of the pigments of the disperse ink into the surface layer of the slab by means of a phase transition so as to produce said chromatic effects.

3. The method according to claim 1, further comprising after said step of penetration, by means of diffusion, of the pigments of the disperse ink in the surface layer of the slab, a step of application of a layer of functional compound at least on said surface of the slab with said surface chromatic effects, said functional compound being transparent and consisting of a silazane solution.

4. The method according to claim 2, characterized in that said mix comprises granules and/or powders which have a light-coloured pigmentation.

5. The method according to claim 1, characterized in that said chromatic effects are formed on the surface of the superficial layer with a predefined pattern corresponding to and/or aesthetically compatible with a predefined pattern of said veins.

6. The method according to claim 2, characterized in that said chromatic effects are formed on the surface of the surface layer with a predefined pattern corresponding to and/or aesthetically compatible with a predefined pattern of said veins formed in the layer of additional mix.

7. (canceled)

8. The method according to claim 2, characterized in that the layer of mix and the corresponding surface layer of the hardened slab have, respectively, thicknesses smaller than the thickness of the layer of additional mix and of the corresponding main body of the hardened slab.

9. (canceled)

10. The method according to claim 1 claims, characterized in that, during said diffusion penetration step, the pigments of said disperse ink undergo a phase transition from solid to liquid/gaseous or from liquid to gaseous.

11. The method according to claim 1, characterized in that, said disperse ink is a sublimation ink, said diffusion penetration step being performed by means of sublimation of the pigments of said sublimation ink.

12. The method according to claim 3, further comprising following said step of penetration by means of diffusion of the pigments in the surface layer of the slab and before said step of application of the layer of functional compound, a further step of cooling the stab and/or a step of removing the excess or residual ink from the surface of the slab.

13. The method according to claim 3, further comprising before the step of application of the layer of functional compound, a step involving polishing said surface of the slab.

14. The method according to claim 1, characterized in that said step of applying said disperse ink on said at least one surface is preceded by a step involving application and drying of a primer, said primer consisting of a solution or dispersion of organic and/or inorganic compounds compatible with the process for direct application of the disperse ink onto the slab.

15-16. (canceled)

17. The method according to claim 4, characterized in that the material of the granules and/or powders of said mix is quartz or cristobalite and/or a synthetic mineral containing calcium silicate crystals and/or in that the granules and/or powders of said mix have a particle size of between 0.1 mm and 0.3 mm.

18. (canceled)

19. The method according to claim 1, characterized in that the step of application of the disperse ink is performed by arranging on the surface of the slab a sheet which has the chromatic effect pre-printed thereon with the disperse ink to be applied onto the surface of the slab.

20. The method according to claim 1, characterized in that said step of application of the disperse ink is performed by applying the ink directly onto the surface of the slab by means of a digital printer or plotter.

21. The method according to claim 1, characterized in that at least said step of distribution of said at least one layer of mix is performed by means of rolling.

22. The method according to claim 2 characterized in that the step of distribution of the mix is performed following the step of distribution of the additional mix and the step of formation of the veins.

23. (canceled)

24. The method according to claim 1, characterized in that said step of penetration of the pigments is performed by means of the action of a heat source and/or the application of a predetermined pressure.

25. A plant for manufacturing slabs made of stone or stone-like agglomerate material and having veins and surface chromatic effects, which plant comprises:
at least one station comprising means for distribution of at least one layer of mix comprising a binding resin on a temporary support;
a station comprising means for forming veins in the at least one layer of mix;
a station comprising means for compaction of the at least one layer of mix distributed on the temporary support;
a station comprising means for performing catalysis of the binding resin of the at least one mix;
a station comprising means for cooling the at least one layer of mix so as to obtain a hardened slab;
a station comprising means for machining the surface of the slab by means of sizing and/or smoothing and/or polishing of the visible surface of the slab; and
a station comprising means for the application, drying and penetration by means of diffusion of a disperse ink containing pigments on the machined surface of the slab so as to provide the surface chromatic effects.

26. The plant according to claim 25, comprising:
a station comprising means for distribution of a layer of mix on a temporary support;
a station comprising means for distribution of a layer of an additional mix on the temporary support so as form a sandwich arrangement;
a station comprising means for forming veins in the layer of additional mix;
a station comprising means for compaction of the sandwich arrangement of mixes distributed on the temporary support;
a station comprising means for performing catalysis of the binding resins of the mixes;
a station comprising means for cooling the sandwich arrangement of mixes so as to obtain a hardened slab;
a station comprising means for surface-machining the slab by means of sizing and/or smoothing and/or polishing of the visible surface of the slab;
a station comprising means for the application, drying and penetration by means of diffusion of a disperse ink containing pigments on the machined surface of the slab so as to provide the surface chromatic effects.

27. The plant according to claim 25, further comprising a control unit which has an installed software and is connected to said stations, the means for forming the veins and the means of said station for applying the disperse ink being controlled by said control unit so that the veins and the surface chromatic effects are realized with predefined patterns corresponding to each other.

28-29. (canceled)

30. The plant according to claim 25, further comprising a station comprising means for application of a layer of functional compound on the surface of the slab located downstream of said station, comprising means for application, drying and penetration by means of diffusion of a disperse ink.

31. A slab made of stone or stone-like agglomerate material comprising:
a surface layer having a light-coloured, pigmentation and with a visible surface provided with surface chromatic effects realized by means of diffusion penetration of a disperse ink; and
a main body provided with veins in the thickness.

32. The slab according to claim 31, characterized in that said chromatic effects of the surface layer have a predefined pattern corresponding to and/or aesthetically compatible with a predefined pattern of said veins formed in said main body.
